(19) United States
(12) Patent Application Publication
(10) Pub. No.: US 2008/0152792 A1
(43) Pub. Date: Jun. 26, 2008

(54) METHOD OF MANUFACTURING A BISTABLE MICROELECTRONIC SWITCH STACK

(75) Inventors: Ke K. Lian, Palatine, IL (US); Marc K. Chason, Schaumburg, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/614,472

(22) Filed: Dec. 21, 2006

(51) Int. Cl. B05D 5/12

(52) U.S. Cl. 427/126.1

(57) ABSTRACT

A stack for a bistable microelectronic switch is fabricated by providing a first metal electrode on a supporting substrate. A bistable macrocyclic compound is printed over the first electrode using a high speed printing process. A conductive polymer is then printed over the bistable macrocyclic compound using a high speed printing process, and a second electrode is then formed on the conductive polymer. Copper phthalocyanine is one bistable compound, and a combination of poly-(3,4-ethylenedioxythiophene) and poly-(styrenesulphonic acid) is the conductive polymer. The upper and lower electrodes are formed in a crossbar formation to create an addressable random access memory device. When a voltage less than a switching voltage is applied between two intersecting electrodes, the resistance is very high, and when a voltage greater than the switching voltage is applied, the resistance is generally two orders of magnitude lower.

### FIELD OF THE INVENTION

The present invention relates generally to methods of manufacturing switching devices having an organic switching layer, and to methods of manufacturing arrays of microelectronic switches.

### CROSS REFERENCE TO RELATED APPLICATION

The present invention is related to attorney's docket number CML03613T, Bistable Microelectronic Switch Stack, filed on even date herewith and having common assignee.

### BACKGROUND

Organic devices promise to revolutionize the extent of, and access to, electronics by providing extremely inexpensive and lightweight components that can be fabricated onto plastic, glass or metal sheets. Data storage is a basic necessity for large area, flexible, electronic assemblies. There has been research in the area of organic printed memory for high density and low cost devices, but most efforts have been focused on using silicon-based technology and processes. Prior art processes generally all require a high precision deposition process to apply the organic molecules and the semiconducting polymer on top of each electrode. This is a limiting step in the process of low cost memory devices. The use of nanotechnology and associated nanomaterials and molecules are good alternate candidates for this application, but the processability and cost of the nanomaterials presents a significant challenge. A simplified, low cost alternative to these prior art techniques would be a significant addition to the art.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is partial cross-sectional view of a bistable microelectronic switch stack, in accordance with some embodiments of the invention.

FIG. 2 is a flow chart depicting one method of manufacturing a bistable microelectronic switch stack, in accordance with some embodiments of the invention.

FIG. 3 is exploded isometric view of an array of bistable microelectronic switches, in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method and apparatus components related to manufacturing a stack for a bistable microelectronic switch. Accordingly, the apparatus components and methods have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional elements, materials, or processes, that, combined in a novel manner, provide a manufacturing method for a bistable microelectronic switch described herein. Thus, methods and means for these functions have also been described herein. Further, it is expected that one of ordinary skill, notwithstanding possibly significant effort and many design choices motivated by, for example, available time, current technology, and economic considerations, when guided by the concepts and principles disclosed herein will be readily capable of generating such stacks with minimal experimentation.

A stack for a bistable microelectronic switch is fabricated by providing a first metal electrode on a supporting substrate. A bistable macrocyclic compound, such selected from the porphyrin family, is printed over the first electrode using a high speed printing process. An electrically conducting material, for example a conductive polymer is then printed over the bistable porphyrin compound using a high speed printing process, and a second electrode is then created on the conductive polymer, by printing or other conventional means. One embodiment of the switch prints a layer of copper phthalocyanine as the bistable compound, and prints a layer of poly-(3,4-ethylenedioxythiophene) and poly-(styrenesulphonic acid) as the conductive polymer. One application of the switch is to form an array of switches to create a random access memory device. When a voltage less than a switching voltage is applied between the two electrodes, the resistance is very high, and when a voltage greater than the switching voltage is applied, the resistance is generally two orders of magnitude lower.

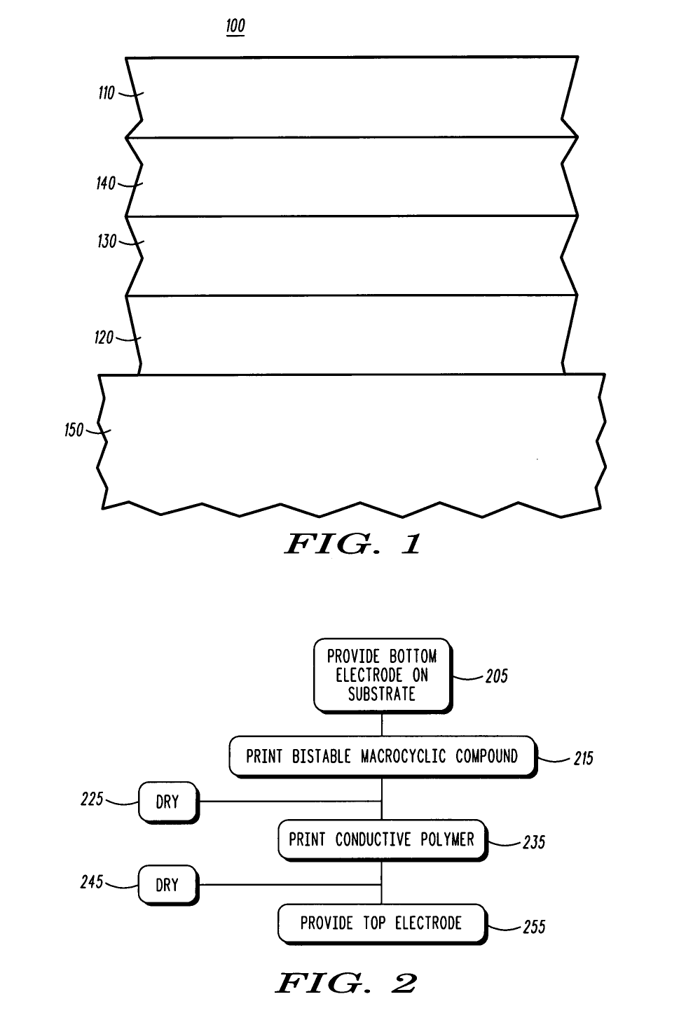

Referring now to FIGS. 1 and 2, a bistable switch stack 100 for use in microelectronics applications has a top electrode 110, a bottom electrode 120, an organic bistable layer 130 and a conducting polymer 140 sandwiched between the two electrodes. When a voltage or field is applied to the two electrodes, the organic bistable layer changes impedance at a certain voltage, changing from diode-like behavior (Schottky with very high resistance) to resistor-like behavior (ohmic resistances about 2 or more orders of magnitude lower). The stack is built upon a supporting substrate 150, such as a flexible or rigid polymer, glass-reinforced polymers, ceramic, glass, or silicon, but one could also fabricate the stack on a releasable substrate, which would be peeled away after the stack is complete. The bottom electrode 110 is preferably made of copper, but can also be other metals or materials such as aluminum, gold, silver, titanium, nickel, carbon and carbon nanotubes. The bottom electrode is created 205 by any of a number of conventional means, such as etching a pattern in a laminated layer of metal, electroless plating, vacuum deposition, screen printing, etc., or combinations of these methods. For example, one can print a series of conductive patterns or circuit traces on the substrate using silver-filled, carbon-filled, or an intrinsically conductive polymer ink. The organic bistable layer 130 is then printed 215 over the electrode, and optionally, on portions of the substrate, using a high speed printing process. Some examples of suitable printing processes are screen printing, gravure printing, offset printing, ink jetting, and flexography. During the printing process, the material to be printed is an admixture in a liquid state, such as a solution of the desired material in one or more solvents, or a suspension or slurry of the material particles in a liquid. Contact printing typically employs a platen that is inked in a pattern with the liquid material to be printed, and then contacted to the substrate to produce the desired pattern of the material in a selected area. Generally, the printed liquid material needs a finite period of time to dry 225, from seconds to hours, and may even require heating for complete drying, depending on the amount and type of carrier solvents used. In one embodiment, the layer 130 is printed in a continuous sheet over the electrode, and in another embodiment, the layer is printed as one or more discrete areas in a pattern. The organic bistable layer 130 is a macrocyclic compound, generally of the porphyrin family. We find that 5,10,15,20-tetrakis(4-methoxyphenyl)-21H,23H-porphine cobalt(II), copper phthalocyanine, and salts thereof are particularly effective.

The conducting polymer 140 is then printed 235 on the organic bistable layer 130 using a high speed printing process, as described above for printing the layer 130. The type of process used can be the same, or it can be a different technique, as dictated by manufacturing and material concerns. Some examples of suitable printing processes are screen printing, gravure printing, offset printing, ink jetting, and flexography. As previously described, the conducting polymer to be printed is an admixture in a liquid state, such as a solution of the desired material in one or more solvents, or a suspension or slurry of the material particles in a liquid, and generally needs a finite period of time to dry 245, depending on the amount and type of carrier solvents used. In one embodiment, the conducting polymer 140 is printed in a continuous sheet over the bistable layer 130, and in another embodiment, the conducting polymer is printed as one or more discrete areas in a pattern. We find that a preferred conducting polymer is a combination of poly-(3,4-ethylenedioxythiophene) and poly-(styrenesulphonic acid), also known as PEDOT:PSS.

Overlying the conductive polymer layer 140 is a top electrode 110. In one embodiment, the electrode 110 is printed 255 on the conductive polymer layer using an ink having silver, carbon, carbon nanotube, copper, gold or aluminum filler as the conductive material. In another embodiment, the electrode 110 is formed 255 by vacuum depositing one or more metals such as silver, carbon, carbon nanotube, copper, gold, or aluminum.

When a voltage less than a switching voltage, defined herein as between about 1.5 volts and 2 volts, is applied between (i.e. across) the electrodes 110, 120, the impedance, and therefore the amount of current that can be conducted between the electrodes, is very low. At voltages between zero and the switching voltage, the impedance remains relatively constant until, at the switching voltage, the bistable macrocyclic compound undergoes a reversible electrochemical redox reaction and the impedance changes significantly. We have observed impedance changes from about two orders of magnitude (100 times) to about 4 orders of magnitude (10,000 times). The amount of current that can be conducted across the two electrodes increases in a step function manner by multiple orders of magnitude at the switching voltage, then proceeds to climb in a linear fashion as the voltage is increased further.

Below the switching voltage, the stack 100 behaves electrically like a diode, that is, essentially non-conducting. Once the switching voltage is reached, the stack changes and now behaves electrically like a fixed resistor, where the amount of current that can be conducted is a direct function of the voltage, per Ohm's Law. Once the voltage field is removed, the stack remains at the “switched” behavior in a resistive state. That is, the bistable macrocyclic compound does not revert, until a lower voltage is presented.

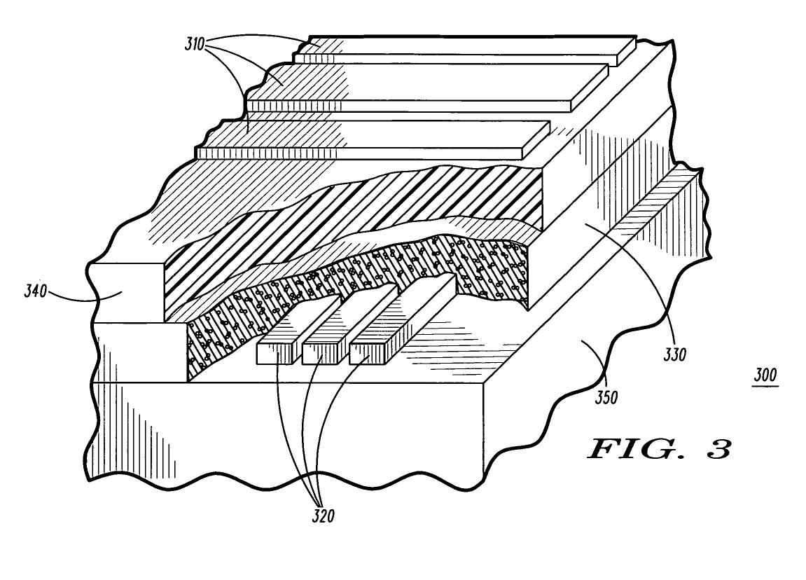

Referring now to FIG. 3, the method described above can be modified in an alternate embodiment of our invention to form an array of bistable switches to create a memory device 300, such as a random access memory. A plurality of bottom or lower metal electrodes 320 are arranged on a substrate 350 in an array. The bottom electrodes 320 are preferably made of aluminum, but can also be other metals and materials such as copper gold, silver, titanium, nickel, carbon and carbon nanotube. The bottom electrode can be formed by any of a number of conventional means, such as etching a pattern in a laminated layer of metal, electroless plating, vacuum deposition, screen printing, etc., or combinations of these methods. Although the drawing figure shows the electrode array as a one dimensional array of strips, wherein the electrodes are a series of lines that are parallel to each other, it can also be a two dimensional array, where the electrodes are formed in a shape and repeated in a regular or irregular pattern. Optionally, the individual electrodes in the array can be connected to a common bus.

An organic bistable layer 330 is then printed over the array of electrodes, and optionally, on portions of the substrate, using a high speed printing process such as screen printing, gravure printing, offset printing, ink jetting, and flexography. During the printing process, the material to be printed is an admixture in a liquid state, such as a solution of the desired material in one or more solvents, or a suspension or slurry of the material particles in a liquid. Generally, the printed liquid material needs a finite period of time to dry, depending on the amount and type of carrier solvents used. In one embodiment, the layer 330 is printed in a continuous sheet over the electrodes, so that it is common to each of the individual electrodes in the array. In another embodiment, the layer is printed as one or more discrete areas in a pattern. The organic bistable layer 330 is a macrocyclic compound, generally of the porphyrin family. We find that 5,10,15,20-tetrakis(4-methoxyphenyl)-21H,23H-porphine cobalt(II) and salts thereof are particularly effective.

A layer of conducting polymer 340, such as PEDOT:PSS, is deposited on top of the organic bistable material 330 using for example, a high speed printing process, as described above. In one embodiment, the conducting polymer 330 is printed in a continuous sheet over the bistable layer, and in another embodiment, the conducting polymer is printed as one or more discrete areas in a pattern.

A top or upper array of electrodes 310 is then formed on the conducting polymer 340. In one embodiment, the electrodes 310 are printed on the conductive polymer layer 340 using an ink having silver, carbon, carbon nanotube, copper, gold or aluminum filler as the conductive material. In another embodiment, the electrodes 310 are formed by vacuum depositing one or more metals such as silver, carbon, carbon nanotube, copper, gold, or aluminum. In the case where the bottom electrodes 320 are arranged in a one dimensional array, (i.e. a series of parallel lines or strips), the top electrode array is, preferably, likewise a one dimensional array, with the lines situated orthogonally to the bottom electrodes. Optionally, one could arrange the lines at other angles that are not right angles. This “crossbar” arrangement provides a matrix of uniquely addressable locations at the intersection of each upper and lower electrode. Due to a donor-acceptor charge transfer mechanism, an anisotropic conduction path where a lower electrode intersects an upper electrode is created via a “most preferred” path. That is, the conductive path is vertical between the electrodes at the intersection, and does not cross horizontally or at an angle to another adjacent electrode on either layer. Devices built in this manner with common bistable layer 330 and common conducting polymer layer 340 were subjected to writing cycles at locations “A” and “B” in FIG. 3 by varying the voltage past the switching voltage, and the two switches A and B exhibited independent behavior. That is, writing (applying the switching voltage) at location A did not affect the value of location B, and vice versa.

In summary, a method of manufacturing a bistable microelectronic switch uses high speed printing processes to print a layer of a porphyrin compound and a conductive polymer that are sandwiched between two electrodes. When a voltage greater than zero and less than about 2 volts is applied between the first electrode and the second electrode, the resistance across the two electrodes is very high, and when a voltage of greater than about 2 volts is applied, the resistance is generally two orders of magnitude lower. It can be used in arrays to form a memory device.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method of manufacturing a bistable switch, comprising:
providing a substrate having a first electrode, situated on a major face of the substrate;
depositing, via one or more high speed printing processes, a bistable macrocyclic compound on the first metal electrode;
depositing, via one or more high speed printing processes, a conductive polymer on the printed bistable macrocyclic compound; and
providing a second electrode on the conductive polymer.

2. The method of manufacturing a bistable switch as described in claim 1, wherein printing the bistable macrocyclic compound comprises printing copper phthalocyanine or 5,10,15,20-tetrakis(4-methoxyphenyl)-21H,23H-porphine cobalt(II).

3. The method of manufacturing a bistable switch as described in claim 1, wherein printing the conductive polymer comprises printing poly-(3,4-ethylenedioxythiophene) and poly-(styrenesulphonic acid).

4. The method of manufacturing a bistable switch as described in claim 1, wherein the first electrode comprises one or more materials selected from the group consisting of copper, aluminum, gold, silver, titanium, carbon, carbon nanotubes, and nickel.

5. The method of manufacturing a bistable switch as described in claim 1, wherein providing the second electrode comprises printing silver filled conductive ink.

6. The method of manufacturing a bistable switch as described in claim 1, wherein printing the bistable macrocyclic compound comprises printing at a plurality of discrete locations.

7. The method of manufacturing a bistable switch as described in claim 1, wherein the bistable macrocyclic compound is printed on the first metal electrodes and on portions of the substrate.

8. The method of manufacturing a bistable switch as described in claim 1, wherein the one or more high speed printing processes are selected from the group consisting of screen printing, gravure printing, offset printing, inkjet printing, dispensing, and flexography.

9. A method of manufacturing a bistable switch array, comprising:
providing a substrate having a plurality of first electrodes arranged in an array, situated on a major face of the substrate;
printing a solution of a bistable macrocyclic compound to form a layer on the plurality of first electrodes and on exposed portions of the substrate via one or more high speed printing processes selected from the group consisting of screen printing, gravure printing, offset printing, inkjet printing, dispensing, and flexography;
drying the printed bistable macrocyclic compound;
printing a solution of a conductive polymer to form a layer on the dried bistable macrocyclic compound via one or more high speed printing processes selected from the group consisting of screen printing, gravure printing, offset printing, inkjet printing, dispensing, and flexography;
drying the printed conductive polymer;
providing a plurality of second electrodes arranged in an array associated with the first electrode array on the dried conductive polymer.

10. The method of manufacturing a bistable switch array as described in claim 9, wherein the bistable microelectronic switch array comprises a random access memory device.

11. The method of manufacturing a bistable switch array as described in claim 9, wherein providing a plurality of second electrodes comprises printing conductive ink having silver, carbon, carbon nanotube, copper, gold or aluminum.

12. The method of manufacturing a bistable switch array as described in claim 9, wherein providing a plurality of second electrodes comprises vacuum depositing one or more metals selected from the group consisting of silver, carbon, carbon nanotube, copper, gold, and aluminum.

13. The method of manufacturing a bistable switch array as described in claim 9, wherein the plurality of first electrodes are arranged in a two dimensional array.

14. The method of manufacturing a bistable switch array as described in claim 9, wherein the plurality of second electrode are arranged in a two dimensional array.

15. A method of manufacturing a bistable switch array, comprising:
providing a substrate having a plurality of first electrodes substantially parallel to each other, situated on a major face of the substrate;
printing a common layer of a liquid admixture of a bistable macrocyclic compound comprising copper phthalocyanine or 5,10,15,20-tetrakis(4-methoxyphenyl)-21H,23H-porphine cobalt(II) on the plurality of first electrodes and on exposed portions of the substrate between the electrodes via a high speed printing process selected from the group consisting of screen printing, gravure printing, offset printing, inkjet printing, dispensing, and flexography;
printing a common layer of a liquid admixture of conductive polymer on the printed bistable macrocyclic compound via a high speed printing process selected from the group consisting of screen printing, gravure printing, offset printing, inkjet printing, dispensing, and flexography;
providing a plurality of second electrodes substantially parallel to each other on the printed conductive polymer, and orthogonal to the plurality of first electrodes such that each of the plurality of second electrodes intersects above each of the plurality of first electrodes.

16. The method of manufacturing a bistable switch array as described in claim 15, further comprising drying the printed liquid admixture of the bistable macrocyclic compound prior to printing the liquid admixture of conductive polymer.

17. The method of manufacturing a bistable switch array as described in claim 15, further comprising drying the printed liquid admixture of conductive polymer prior to printing the providing the plurality of second electrodes.

18. The method of manufacturing a bistable switch array as described in claim 15, wherein printing the conductive polymer comprises printing poly-(3,4-ethylenedioxythiophene) and poly-(styrenesulphonic acid).

19. The method of manufacturing a bistable switch array as described in claim 15, further comprising independently applying a switching voltage across one or more of the electrode intersections.
